(19) United States
(12) Patent Application Publication
(10) Pub. No.: US 2025/0246041 A1
(43) Pub. Date: Jul. 31, 2025

(54) AUTOMATED REFILL VENDING MACHINE

(71) Applicant: Petros Palandjian, Philadelphia, PA (US)

(72) Inventor: Petros Palandjian, Philadelphia, PA (US)

(21) Appl. No.: 19/034,357

(22) Filed: Jan. 22, 2025

Related U.S. Application Data
(60) Provisional application No. 63/624,035, filed on Jan. 23, 2024.

(51) Int. Cl. G07F 13/02; G07F 17/00

(52) U.S. Cl. CPC G07F 13/02; G07F 17/0014

(57) ABSTRACT

A vending machine is provided. The vending machine includes an interactive display unit, one or more dispensers, a tray for supporting a refillable vessel, and internal storage for grocery products. The vending machine may include a payment device. The interactive display unit may be configured to show an environment impact of: a transaction, transactions of an individual across a period of time and/or the vending machine across a period of time. The environment impact may be a number of plastic bottles saved, a weight of the plastic bottles saved, an amount of CO2 mitigated, an amount of money saved, and/or an amount of electricity saved.

### CROSS-REFERENCE TO RELATED APPLICATIONS

This application claims the benefit of U.S. Provisional Application No. 63/624,035, filed Jan. 23, 2024, entitled “Automated Refill Vending Machine”, which is hereby incorporated herein by reference in its entirety.

### TECHNICAL FIELD

The present disclosure relates to systems and methods regarding automated refill-vending machines.

### BACKGROUND

There is a need for increasing sustainability by reducing excessive packaging when buying groceries, while not inconveniencing or financially over-extending consumers.

### SUMMARY OF THE EMBODIMENTS

In illustrative embodiments of the invention, a vending machine is provided. The vending machine includes an interactive display unit, one or more dispensers, a tray for supporting a refillable vessel, and internal storage for grocery products.

In accordance with related embodiments of the invention, the vending machine may include a payment device. The interactive display unit may be configured to show an environment impact of: a transaction, transactions of an individual across a period of time and/or the vending machine across a period of time. The environment impact may be a number of plastic bottles saved, a weight of the plastic bottles saved, an amount of CO2 mitigated, an amount of money saved, and/or an amount of electricity saved.

In accordance with further related embodiments of the invention, a method of obtaining a refill of a liquid or dry-good product, may include obtaining a liquid and/or dry good product that is provided in a vessel; and using the above-described vending machine in obtaining a refill of the liquid and/or dry good product. Obtaining a refill of the liquid and/or dry good product may include using the vessel to store the refill. Alternatively, a different vessel may be used to store the refill.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a photograph of an example universal vending machine for liquid products, in accordance with an embodiment of the invention.

FIG. 2A is a perspective view of a diagram of the machine of FIG. 1, in accordance with an embodiment of the invention.

FIG. 2B is another perspective view of a diagram of the machine of FIG. 1, detailing internal components, in accordance with an embodiment of the invention.

FIG. 2C is a side view of a diagram of the machine of FIG. 1, detailing internal components, in accordance with an embodiment of the invention.

FIG. 3 is a diagram detailing an overview of operations for the machine of FIG. 1, in accordance with an embodiment of the invention.

FIG. 4A is an example of the interactive display unit of the machine of FIG. 1, detailing a consumer shopping experience, in accordance with an embodiment of the invention.

FIG. 4B is an example of the interactive display unit of the machine of FIG. 1, detailing a consumer gamified platform experience, in accordance with an embodiment of the invention.

FIGS. 5A-5H are additional examples of user interface (UI) content related to customer usage of the interactive display unit of the machine of FIG. 1, in accordance with various embodiments of the invention.

FIG. 6 is an example of a dry-goods dispenser according to the systems and methods, in accordance with an embodiment of the invention.

FIG. 7 is an example of an alternate machine setup for dispensing liquid grocery products, in accordance with an embodiment of the invention.

FIG. 8 provides an example diagram detailing an overview of database architecture, in accordance with an embodiment of the invention.

### DETAILED DESCRIPTION

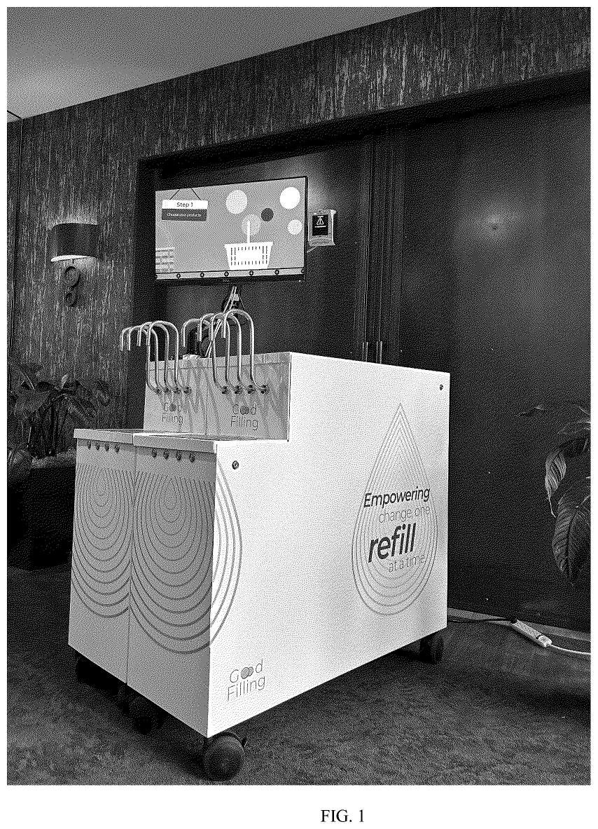

The present disclosure includes systems and methods regarding automated refill-vending machines for consumer-packaged goods (CPG). According to some implementations, these machines can dispense food safe products, including basic liquid and dry-good grocery products, enabling consumers to reuse their existing containers and bottles, and reduce waste. FIG. 1 is an example universal vending machine for liquid products, including, in part, one or more buttons, one or more dispensing nozzles, a payment device (such as, a card reader) and associated mount, an interactive touch-screen display connected to an adjustable monitor arm, modular and removable side panels, a base that can support wheels/casters, a tray for supporting a refillable vessel, and internal storage for dispensable consumer-packaged goods. These products can utilize entirely food safe materials, and can dispense anything from soaps, cleaners, detergents, to cooking oils, broths, beverages, etc. According to some implementations, storage and vending components for dispensing dry grocery products is also included.

These machines can dispense virtually all liquid products, which can be readily interchanged, and may not require specific refillable vessels, including refillable customer vessels and storage vessels within a machine. These machines can convey complex message via a gamified platform and can be custom-designed to enable brand-forward approaches. Further, these display units within machines according to that of the present disclosure can allow for customers to choose products, learn about products, put a hold on their credit card, pay for products, dispense products, track their lifelong reuse journey, etc. via the interactive display unit and/or other components of the vending machine unit. For example, the interactive display can provide information about the product(s) to be dispensed, including: ingredients, product description, product usage guidelines, known allergens, recommended storage vessels, supplier branding, scent information, etc. In this way, these machines can properly inform customers and/or operators of volume data in real-time as dry and/or liquid goods are dispensed.

These machines can be manufactured more cheaply than comparable machines, are smaller and lighter, and are simple and easy for a consumer and/or operator to interact with. According to some implementations, the monitor arm is adjustable, and each interactable component, such as the display, payment device, side panels, and one or more buttons, is accessible in compliance with ADA (Americans with Disabilities Act) requirements. According to some implementations, the machines are manufactured and operate in consideration of NIST and tip-and-fall compliance. These machines can be designed for usage in a home, apartment, condo, apartment building, university, hotel, office building, hospital, grocery store, stadiums, or other environments.

According to some implementations, these vending machine units can include four dispensing taps with shared resources for unit economic gain. For example, these dispensing nozzles/taps can be interchanged to include variables of 4 (such as, 4, 8, 12, 16, 20+ taps). With an emphasis on modularity, virtually any shelf-stable liquid product can be loaded into one of the example machines, including food safe products. Further, each component of these machine, such as those previously provided, can be readily interchanged to provide customizable, modular options for customers and/or operators depending upon the present needs and/or desires of where a machine is installed for usage. This can be achieved without replacing the pump, motor, or gearbox of the machines of the present disclosure. As previously mentioned, these machines can be compatible with all forms of bottles, vessels, and packaging, which can enable the “BYO” system for greater consumer convenience and flexibility. Software and casing can be utilized within these machine units to accommodate a variety of products, and pump and meter options can be present to enable the vending of dry goods. For example, FIG. 6 details a solid dispenser, capable of dispensing dry goods via a hopper that funnels down to a rotating pump head attached to a gear box, then a motor. More specifically, the dispenser of FIG. 6 can be mounted on top of the machine, such that it utilizes space above the machine and doesn't interfere with its ability to dispense liquids. According to some implementations, the machine remains lockable and sealable from the top, and can dispense over a tray to catch fallen goods. In this example, the dispenser is wired up to a PCB which is able to record the number of rotations, and therefore, ounces dispensed of solid goods.

These machine units can include bag-in-box, as well as carboy connection points, for dispensing, according to some implementations. FIG. 7 illustrates the bag-in-box dispensing setup option, which can be configured to have the remainder of the plumbing attached to the side of a bag-in-box container and pull from the bag itself. This example can also include a connector to connect the hose to the bag-in-box dispensing connector, while otherwise being the same as the carboy setup presented in other examples of the machines of the present disclosure. These machines do not require an openable door to refill grocery products stored internally, which can instead be pumped in via a small hole or like opening, thereby not requiring separate compartments which can be open-and-closed for routine internal access during refills servicing and/or refilling the vending machine unit itself. Additionally, the vending machine units of the present disclosure are not required to include a selection assembly, check-valves, or solenoid valves.

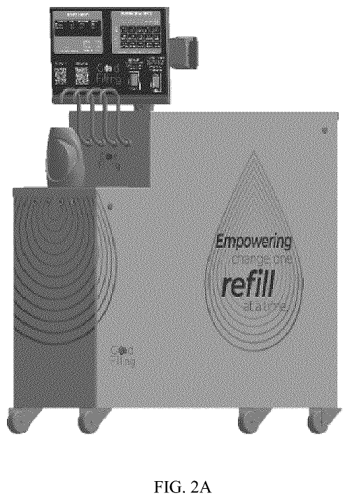

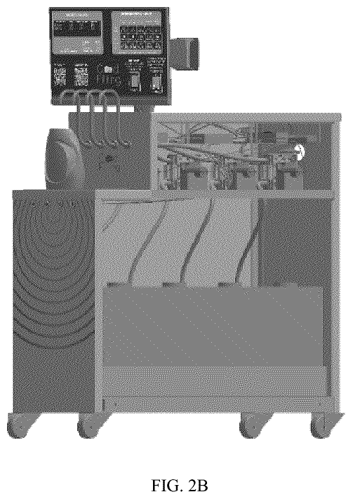

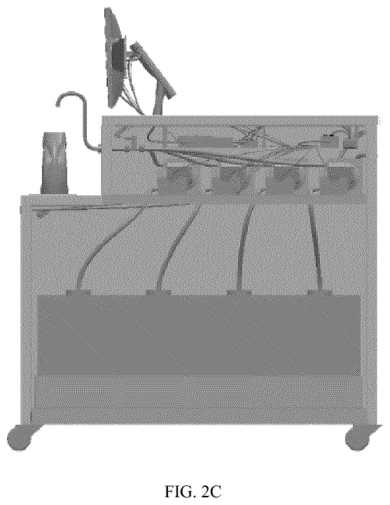

FIGS. 2A-2C provide various views of the universal vending machine of FIG. 1, offering insight into the relationship between various vending components in an operational environment. More specifically, these machine units can utilize unique pumping technology in the dispensing of liquid grocery products, which can include a modular set of hardware that enables 4, 8, 12, 16+ pumps to be configured off of one connected main vending machine, for example. Further, FIGS. 2A-2C demonstrate an example wiring of the flowmeter, motor, and buttons, in addition to an example flow path from carboy to dip tube, to tubing, through the pump, to flow meter, to tubing to nozzle, within the universal vending machines of the present disclosure. FIG. 2B illustrates, via holes at the bottom of the frame, the ability for the modules to connect to one another. Additionally, FIG. 2B shows a hole in the back for supplying power to the internal components of the main/home module of a machine. As shown in FIGS. 2B and 2C, the side panels can be removed for connecting two or more devices together, and showcasing how one device can utilize the main module's computer and power.

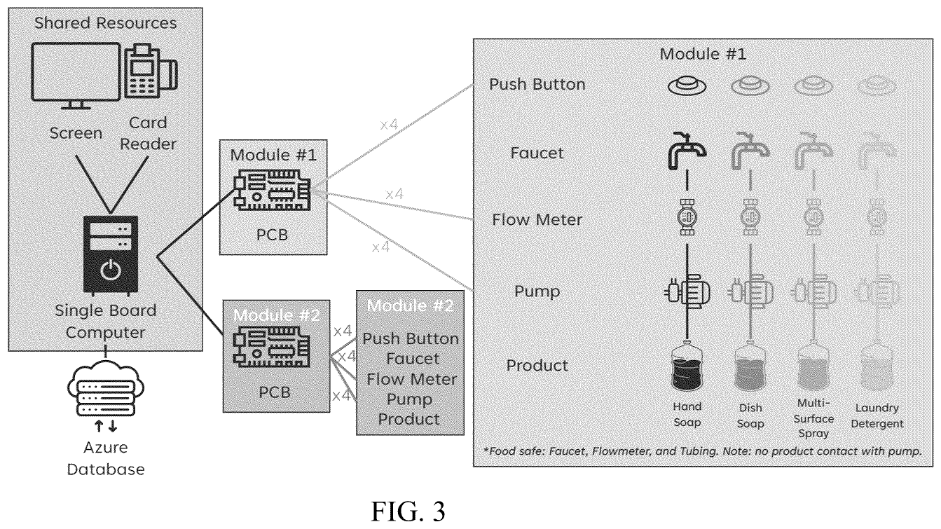

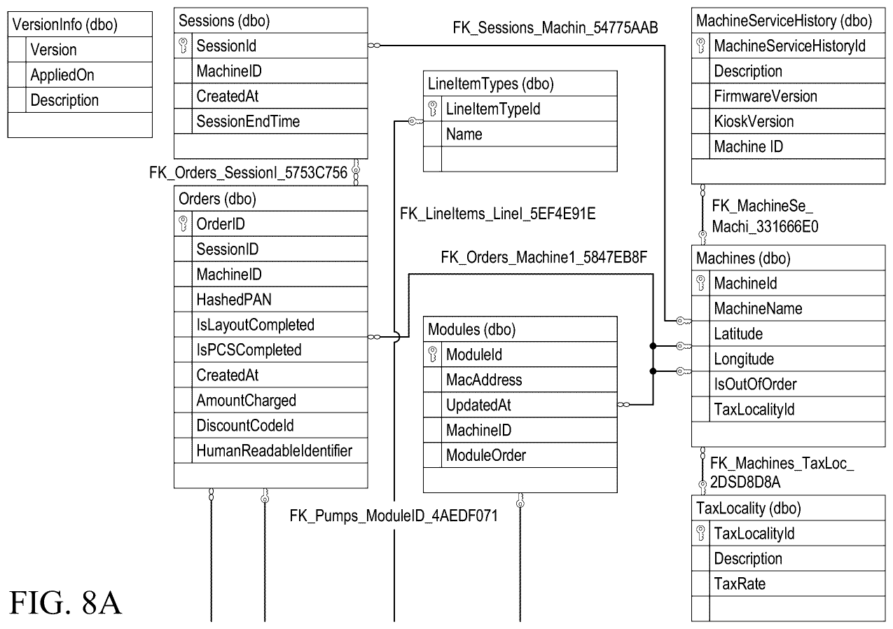

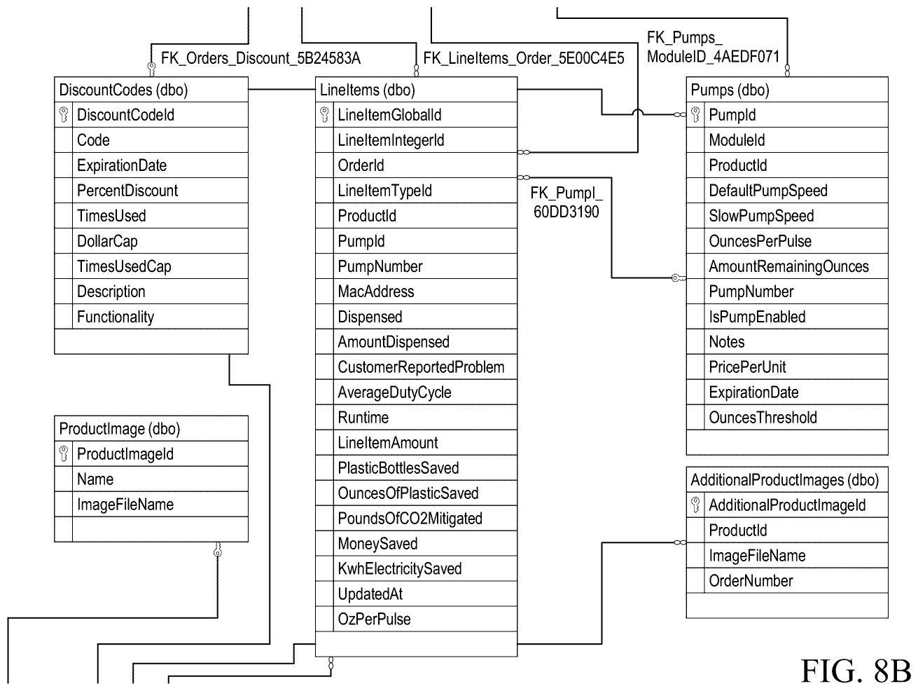

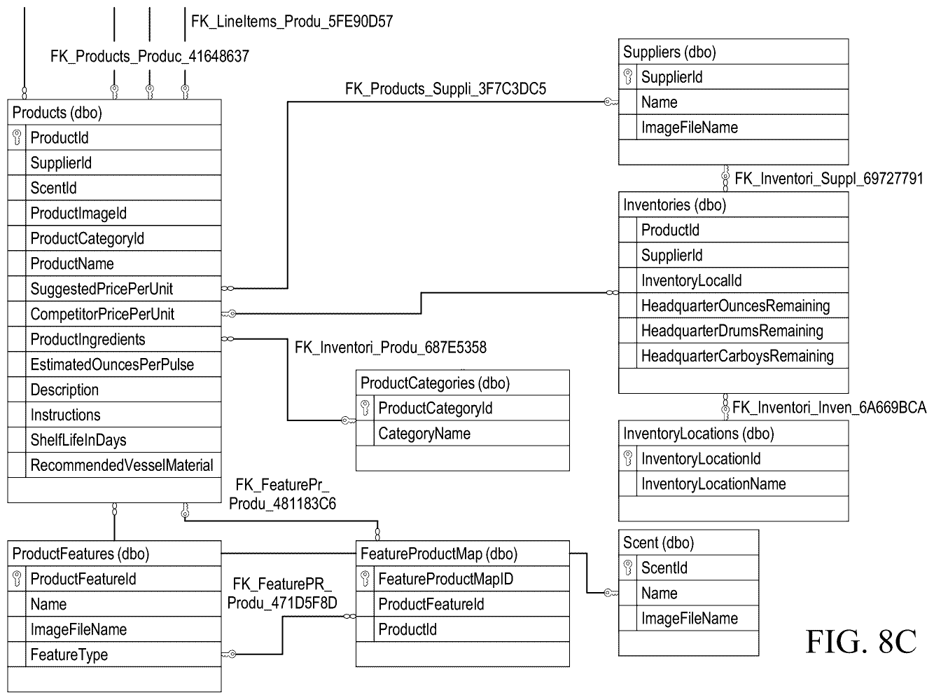

FIG. 3 provides a diagram detailing an overview process of operations for the machine of FIG. 1, illustrating how a consumer command engages various external and internal components of the vending machine in the dispensing and/or vending of grocery products. This process can engage with various components within the vending machine unit via proprietary software, hardware and cloud architectures during operation of the unit, as presented in FIG. 8. In some implementations, this process interacts with a backend that securely stores information about transactions, products, customers (blinded for GDPR/privacy laws), etc. Information can further include data related to sessions, orders, suppliers, photos, GIFs, product features, product info, product usage guidelines, product ingredients, discount codes, inventory counts, location information, machine info, machine service history, module info, product category, pump info, tax info, version info, etc. . . . In some implementations, this data can be exclusively stored via cloud architectures.

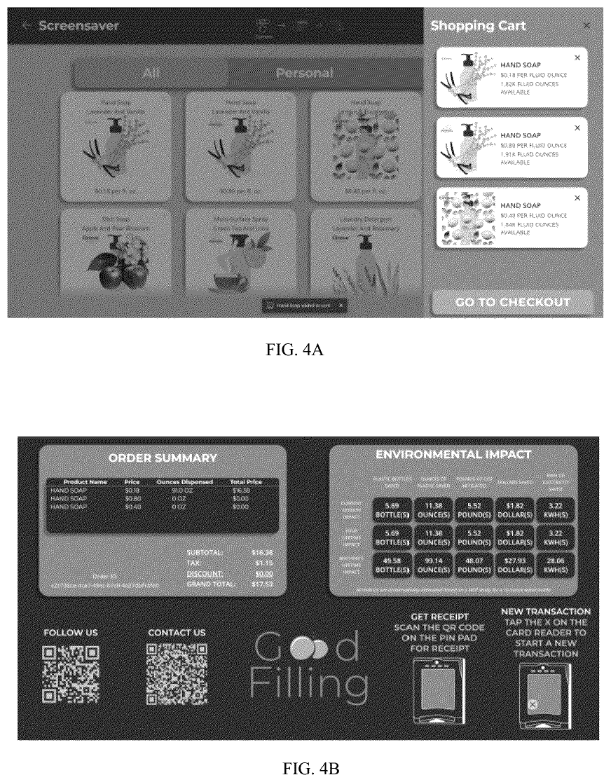

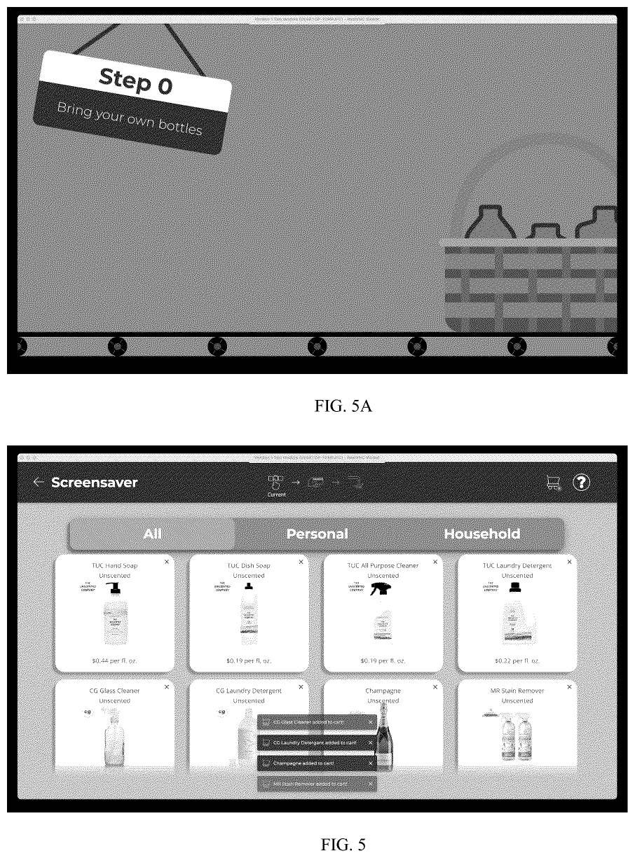

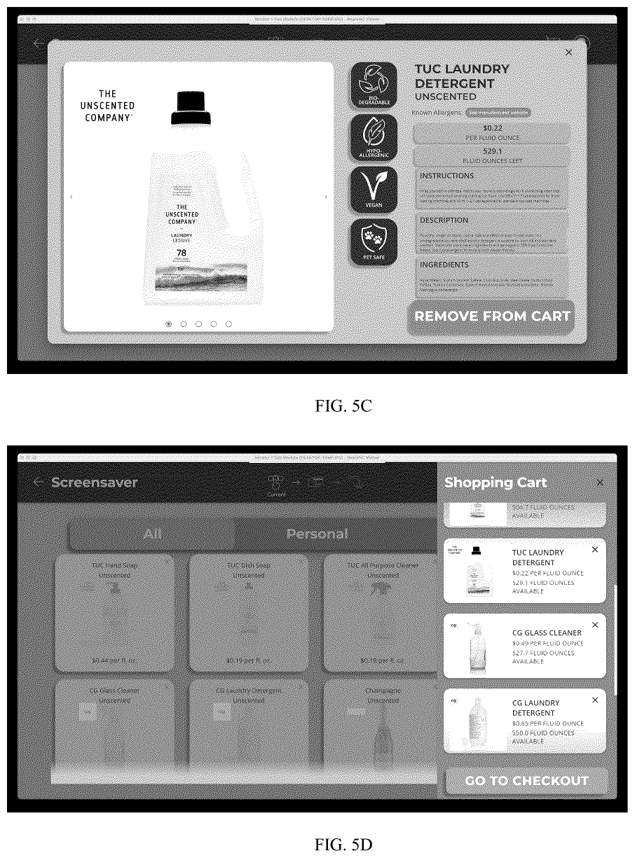

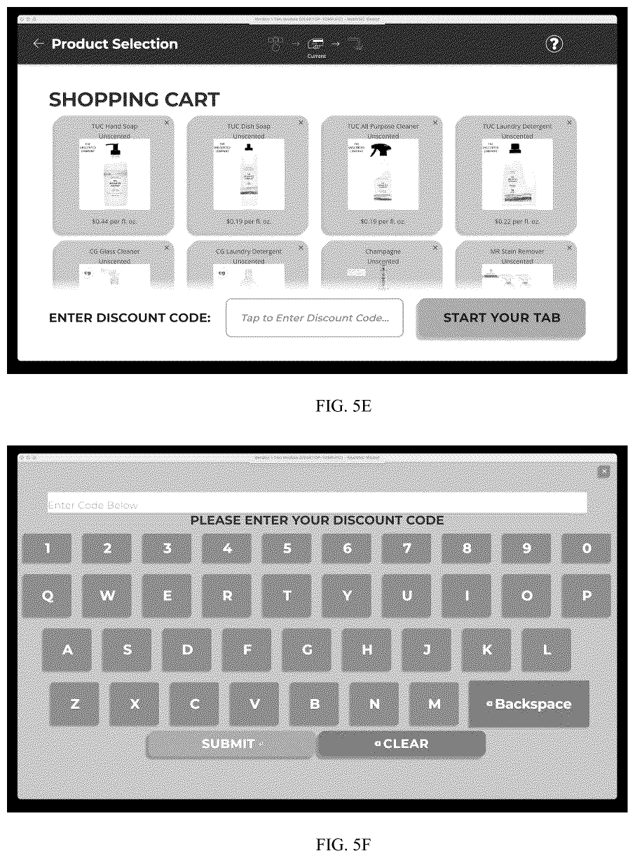

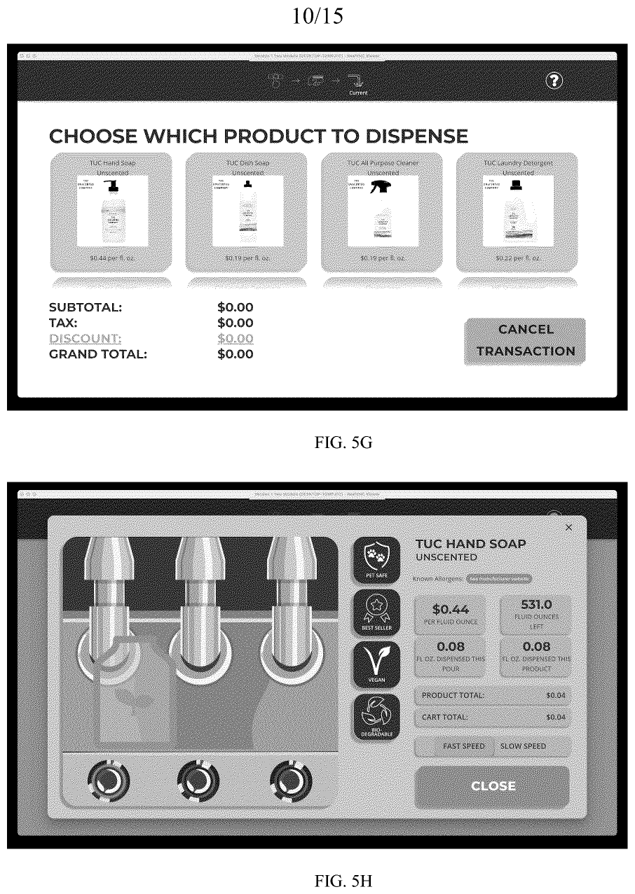

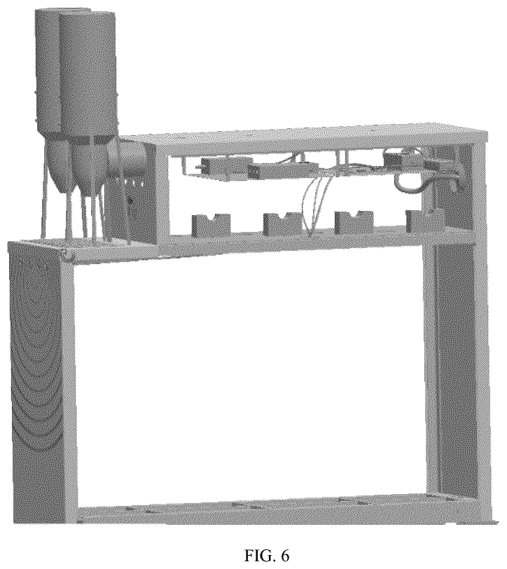

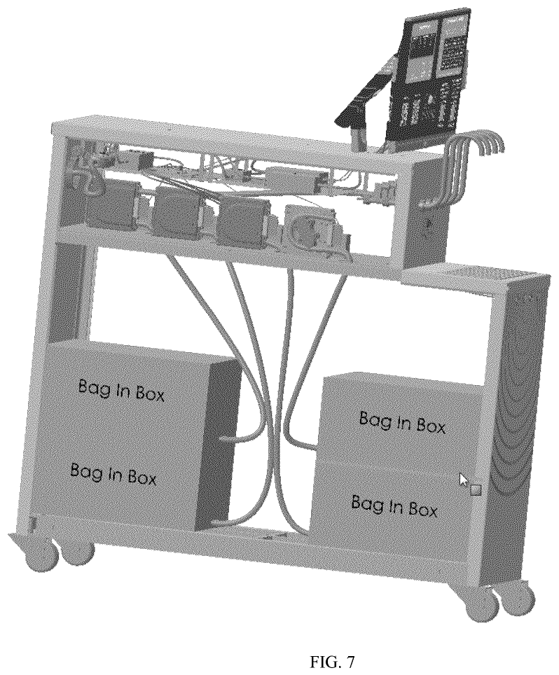

FIG. 4A provides an example of the interactive display unit of the machine of FIG. 1, detailing a consumer shopping experience as the consumer navigates through grocery product options of the vending machine prior to and during checkout. This will be described in further detail in the example illustrated in FIGS. 5A-5H. FIG. 4B provides an example of the interactive display unit of the machine of FIG. 1, detailing a consumer gamified platform experience as the consumer reviews details relating to their Order Summary and Environmental Impact, for example. This can include real-time information relating to present and past transactions, which can include information in consideration of NIST-compliance, such as all the products from the cart, pours dispensed, the price by product, cart totals, including subtotal, tax, discount and grand total. Customers may also have the option to report machine errors via this example. FIG. 4B further details an example of the transaction/individual/machine's environmental impact across its lifetime operation, including: Plastic Bottles Saved, Ounces of plastic saved, pounds of CO2 mitigated, dollars saved, and kWh of electricity saved. The consumer may also engage, via QR codes or like methods, with social media or customer support relating to the vending machine unit, obtain a digital receipt, or begin a new transaction, according to some implementations.

More specifically, the interactive displays of the present disclosure can include additional example user interface features during customer usage, such as those illustrated in FIGS. 5A-5H. FIG. 5A details an example screensaver, which can avoid burning pixels in a static image display of a machine while also providing explanation via a “GIF” to a customer and/or operator regarding how to use the machine. FIG. 5B details an example product selection experience, allowing the user to: view the products on the machine, basic info about each, add a product to their cart, remove a product from their cart, filter by product category, summarize the step of the process they're on, see their cart, get help or learn more, and/or click a product to learn more about it. FIG. 5C illustrates an example of a specific product's details, which can provide additional information about the respective product, including photos, features, scent, known allergens, price per oz, fluid ounces left in our machine, instructions on how to use, description of the product, ingredients of the product, and the option to remove it from the cart, etc. FIG. 5D illustrates an example cart pane that summarizes all the products that have been added, also affording the user the option to remove items from their cart. FIG. 5E illustrates an example screenshot offering customer's an overview of their entire cart, and allowing customers to enter a discount code, see their products again, remove products from their cart, and/or begin the payment process. FIG. 5F illustrates an example screenshot relating to when a customer can enter a discount code. In some implementations, this feature can also allow operators and/or administrators to activate various features of the machine (e.g. input a code that reverses all the pumps in case one want to empty the machine). FIG. 5G illustrates an example screenshot whereby a customer can choose a product to dispense based on their cart, also enter a discount code, cancel the transaction (if no product has been dispensed), or complete a transaction (if product has been dispensed). FIG. 5H illustrates an example screenshot relating to when a customer engages with dispensing a product by hitting the lit-up button. In some implementations, this can be accompanied by a GIF explaining how to hit the button and dispense. In some implementations, such as that illustrated in FIG. 5H, there may also be details relating to product features, price per fluid ounce, fluid ounces dispensed, the running value of product poured, and a toggle to change speed. It is contemplated that displaying price and number of ounces, with their specific number of significant figures dispensed, can demonstrate operation in consideration of NIST compliance. Details relating to the final order summary can be seen in FIG. 4B, for example.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site. For example, systems and methods utilized by machines of the present disclosure may include multiple computer programs and services in order to provide desired modularity. As introduced in FIG. 3, these can include protocols for controlling pumps, for installing the latest software, for managing all the apps/services, for the card reader, and/or for the main kiosk application itself.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other. In some implementations, a remote login client for technicians, administrators, and/or managers (to check on status of machines, make edits to the server, etc.) can be included.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A vending machine, comprising:
an interactive display unit,
one or more dispensers,
a tray for supporting a refillable vessel, and
internal storage for grocery products.

2. The vending machine according to claim 1, further including a payment device.

3. The vending machine according to claim 1, wherein the interactive display unit is configured to show the environment impact of a transaction, transactions of an individual across a period of time and/or the vending machine across a period of time.

4. The vending machine according to claim 3, wherein the environment impact is selected from the group consisting of a number of plastic bottles saved, a weight of the plastic bottles saved, an amount of CO2 mitigated, an amount of money saved, an amount of electricity saved and combinations thereof.

5. A method of obtaining a refill of a liquid or dry-good product, the method comprising:
obtaining a liquid and/or dry good product that is provided in a vessel; and
obtaining a refill of the liquid and/or dry good product using the vending machine of claim 1.

6. The method of claim 5, wherein obtaining a refill of the liquid and/or dry good product includes using the vessel to store the refill.

7. The method of claim 5, wherein obtaining a refill of the liquid and/or dry good product includes using a different vessel to store the refill.
